(19) United States
(12) Patent Application Publication
(10) Pub. No.: US 2024/0253207 A1
(43) Pub. Date: Aug. 1, 2024

(54) STACKABLE STORAGE DRAWER

(71) Applicant: The Stanley Works Israel Ltd., Rosh Ha'Ayin (IL)

(72) Inventors: Danny BARUCH, Lapid (IL); Gal AVIGAD, Gonen (IL); Doron LIVNE, Ruhama (IL); Idan BARANES, Ramat Hasharon (IL)

(73) Assignee: The Stanley Works Israel Ltd., Rosh Ha'Ayin (IL)

(21) Appl. No.: 18/410,020

(22) Filed: Jan. 11, 2024

Related U.S. Application Data
(60) Provisional application No. 63/482,147, filed on Jan. 30, 2023.

(51) Int. Cl. B25H 3/02; B65D 21/02

(52) U.S. Cl. CPC B25H 3/028; B65D 21/0202

(57) ABSTRACT

A storage module which may form part of a stackable storage system is disclosed. The module includes an upper surface having two front spring loaded latches on one side and two rear tabs formed on the opposite side. A sliding or rotating surface tab is disposed between each pair of a spring loaded latch and rear tab. The module includes front and rear lower projecting steps and can be stacked on each other by inserting the steps under the rear tabs and latches. Various sized containers may be disposed on the upper surface of a module in different configurations by making use of the latches, rear tabs and sliding tabs. The module may be a drawer storage module or a container with a pivoting cover.

### CROSS REFERENCE TO RELATED APPLICATIONS

This application claims the benefit of U.S. Provisional Application No. 63/482,147 filed on Jan. 30, 2023. The entire disclosure of the above application is incorporated herein by reference.

### FIELD OF THE INVENTION

The present invention relates to a stackable storage drawer which may form part of a stackable storage container system which includes a plurality of storage containers which may be secured to each other, for example, for joint movement by a dolly or wheeled cart.

### BACKGROUND

Stackable storage containers are known, for example, the rolling container assembly shown in U.S. Pat. Nos. 8,132,819 and 9,132,543, which are hereby incorporated by reference. The assembly disclosed therein includes a base storage container which is disposable on a cart which is provided with wheels and an integral handle system. At least one further storage container may be removably attached on top of the base container, allowing for multiple containers to be jointly transported. The mechanism for attaching the containers to each other in such systems may include a stacking latch mechanism, for example, as shown in U.S. Patent Application Publication Nos. 2020/0025229 and 2020/0298392 and U.S. Pat. No. 11,486,427, which are hereby incorporated by reference. The mechanism includes a spring loaded pivotable latch having a hook disposed on the lid of the container and a step formed on the lower housing of the container. The latch hook is selectively disposable over the step to thereby secure the containers together. U.S. Pat. No. 8,505,729 discloses a stackable container system in which each container includes a latch member and a ledge formed on the outer surface. The latch of a lower container is foldable over the ledge of an upper container to secure the upper and lower containers together.

With further reference to Prior Art FIG. 13, components of a known stackable system are shown. Container 90 includes base 95 having an interior storage volume and cover 96 pivotably attached to base 95. Base 95 includes step 93 extending downwardly from a lower side edge thereof. Though not shown, a second step having the same structure extends downwardly from the opposite lower side edge. Spring biased latch 92 extends upwardly from the upper side edge of cover 96. Though not shown a second spring biased latch having the same structure would extend upwardly from the opposite side edge of cover 96. T-Tab 91 extends upwardly from a central region of cover 96 and has two overhanging ledges. T-Tab may be raised or lowered from the upper surface of cover 96. Conventional accessory box 94 includes base 98 and pivotable cover 97 disposed thereon. Step 93′ having the same structure as step 93 extends downwardly from a lower long side edge thereof. Though not shown a second step having the same structure would extend from the opposite long side edge thereof. Spring biased latch 92′ having the same structure as spring biased latch 92 extends upwardly from the front side edge of cover 97. To secure accessory box 94 onto container 90, step 93′ is inserted beneath a ledge of raised T-Tab 91, and the opposite side step is secured beneath the second spring biased latch of container 90. The not shown second step 93′ contacts the hook of the not shown second latch 92 to rotate latch 92 outwardly until step 93′ clears the hook to allow latch 92 to rotate back inwardly under the spring bias such that the hook overlies step 93′. Alternatively, T-Tab 91 could be lowered and a container having substantially the same overall lower surface area as the upper surface of cover 96 of container 90 could be secured between spring biased latch 92 and the not shown second latch 92. A further container could be secured on cover 97 between spring biased latches 92′. The structure of latches 92,92′ and steps 93,93′ could, for example, have the structure as shown in the above-referenced published patent applications and patents.

With reference to Prior Art FIG. 14, a further known stackable storage system is disclosed. The stackable storage system includes a plurality of stackable storage containers 60(a), 60(b) and 60(c), of substantially the same surface area but having varying depth, each of which includes a cover having latch mechanisms 92 disposed thereon. Containers 60(b) and 60(c) each have steps 93. Chest 60(a) is the lowest container of the stack and may be integrally formed with wheels and an upright pull handle to allow the stackable storage system to be transported by tilting and rolling. Upper container 60(c) has the same structure as container 90 described above. The incorporation of latches 92, steps 93, and T-Tab 91 allows containers of various depths and surface areas to be incorporated into and secured in the stackable storage system.

### SUMMARY OF THE INVENTION

In a first embodiment the invention is directed to a drawer storage module including a drawer storage housing having first and second sides and further including an upper surface extending between the first and second sides. The drawer storage module housing includes first and second latches secured adjacent the upper surface on one of the first and second sides, first and second side tabs disposed adjacent the upper surface on the other of the first and second sides opposite the first and second latches, respectively, and having ledges overhanging the upper surface. The drawer storage module housing further includes first and second surface tabs projecting upwardly from the upper surface, with each said surface tab having a pair of ledges spaced from the upper surface. The first surface tab is disposed between the first latch and first side tab and the second surface tab is disposed between the second latch and the second side tab. The drawer storage module includes at least one storage drawer slidable into and out of the drawer storage module housing. A first container having an interior storage space and a pair of first container steps formed on opposite lower sides thereof may be removably disposed on the upper surface with one of the pair of first container steps secured beneath one of the first or second latches and the other of the pair of first container steps secured beneath the ledge of the corresponding opposite first side tab or second side tab. A second container having an interior storage space and a pair of second container steps formed on opposite lower sides thereof may be removably disposed on the upper surface in a first configuration in which one of the pair of second container steps is secured beneath one of the first or second latches and the other of the pair of second container steps is secured beneath a ledge of one of a corresponding first or second surface tab or in a second configuration in which one of the pair of second container steps is secured beneath a ledge of one of a corresponding first or second surface tab and beneath the ledge of the corresponding first side tab or second side tab.

In a further embodiment the invention is directed to a container system including a drawer storage module, a first container and a second container. The drawer storage module includes a drawer storage housing having first and second sides and an upper surface extending between the first and second sides. The drawer storage module housing includes first and second latches secured adjacent the upper surface on one of the first and second sides, first and second side tabs disposed adjacent the upper surface on the other of the first and second sides opposite the first and second latches, respectively, and ledges overhanging the upper surface. The drawer storage module housing includes first and second surface tabs projecting upwardly from the upper surface, with each surface tab having a pair of ledges spaced from the upper surface. The first surface tab is disposed between the first latch and the first side tab and the second surface tab is disposed between the second latch and the second side tab. The drawer storage module further includes at least one storage drawer slidable into and out of the drawer storage module housing. The first container includes an interior storage space and a pair of first container steps formed on opposite lower sides thereof. The second container comprised an interior storage space and a pair of second container steps formed on opposite lower sides thereof. The first container may be removably disposed on the upper surface in a first configuration in which one of the pair of second container steps is secured beneath one of the first or second latches and the other of the pair of second container steps is secured beneath a ledge of one of a corresponding first or second surface tab or in a second configuration in which one of the pair of second container steps is secured beneath a ledge of one of a corresponding first or second surface tab and beneath the ledge of the corresponding first side tab or second side tab.

In a further embodiment the invention is directed to a container system including a drawer storage module further including a drawer storage housing having first and second sides and an upper surface extending between the first and second sides, and at least one storage drawer slidable into and out of said drawer storage module housing. A first container is removably securable on the upper surface and includes a first container base having an interior storage space and a first container cover having an internal surface and an external surface, with the first container cover pivotable between a closed position in which the internal surface encloses the interior storage space and an open position in which the internal surface does not enclose the interior storage space. A second container is removably securable on the upper surface and includes a second container base having an interior storage space and a second container cover having an internal surface and an external surface. The second container cover pivotable between a closed position in which the internal surface encloses the interior storage space and an open position in which the internal surface does not enclose the interior storage space. Both the first container and the second container may be simultaneously secured on the upper surface with both the first container cover and the second container cover in the open position in a first configuration in which the internal surface of each of the first container cover and the second container cover face each other, a second configuration in which the internal surface of each of said first container cover and said second container cover face away from each other, and a third configuration in which the internal surface of the first container cover faces the external surface of the second container cover.

In a further embodiment, the invention is directed to a drawer storage module having a drawer storage housing having first and second sides and further including an upper surface extending between the first and second sides. The drawer storage module housing includes first and second latches secured adjacent the upper surface on one of the first and second sides, first and second side tabs disposed adjacent the upper surface on the other of the first and second sides opposite the first and second latches, respectively, and ledges overhanging the upper surface. First and second surface tabs project upwardly from the upper surface. Each surface tab has a pair of ledges spaced from the upper surface. The first surface tab is disposed linearly between the first latch and the first side tab and the second surface tab is disposed linearly between the second latch and the second side tab. At least one storage drawer is slidable into and out of the drawer storage housing.

In a further embodiment the invention is directed to a container having first and second sides. An upper surface extends between the first and second sides. First and second latches are secured adjacent the upper surface on one of the first and second sides. First and second side tabs are disposed adjacent the upper surface on the other of the first and second sides opposite the first and second latches, respectively, and have ledges overhanging the upper surface. First and second surface tabs project upwardly from the upper surface. Each surface tab has a pair of ledges spaced from the upper surface. The first surface tab is disposed linearly between the first latch and the first side tab and the second surface tab is disposed linearly between the second latch and second side tab.

These and other objects, features, and characteristics of the present invention, as well as the methods of operation and functions of the related elements of structure and the combination of parts will become more apparent upon consideration of the following description and the appended claims with reference to the accompanying drawings, all of which form a part of this specification, wherein like reference numerals designate corresponding parts in the various figures. It is to be expressly understood, that the drawings are for the purpose of illustration and description only, and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural references unless the context clearly dictates otherwise.

### BRIEF DESCRIPTION OF THE DRAWINGS

FIG. 1 is a left front side perspective view of a stackable storage drawer according to the invention.

FIG. 2 is an overhead right side perspective view of the stackable storage drawer shown in FIG. 1.

FIG. 3 is an underside back right side perspective view of the stackable storage drawer shown in FIG. 1.

FIG. 4 is a perspective view of a sliding tab forming part of the stackable storage drawer shown in FIG. 1.

FIG. 5 is a closeup overhead view of a portion of the upper surface of the stackable storage drawer shown in FIG. 1.

FIG. 6 is a perspective view of a locking tab forming part of the stackable storage drawer shown in FIG. 1.

FIG. 7 is a vertical cross section view taken laterally across the stackable storage drawer shown in FIG. 1 and parallel to the front surface.

FIGS. 8A-8L are perspective views of the stackable storage drawer shown in FIG. 1 incorporated into a stackable container system with various containers or other stackable storage drawers disposed thereon in different configurations.

FIGS. 9A-9F are overhead views showing different orientations in which various containers may be secured on the stackable storage drawer shown in FIG. 1.

FIG. 10A is a perspective view showing one container disposed on the stackable storage drawer shown in FIG. 1.

FIG. 10B is a cross-sectional view showing two containers secured in a front to back relationship on the stackable storage drawer shown in FIG. 1.

FIG. 11 is perspective view showing a sliding tab forming part of the stackable storage drawer according to a second embodiment.

FIG. 12 is perspective view showing a rotating tab forming part of the stackable storage drawer according to a third embodiment.

FIG. 13 is a perspective view of a prior art stackable storage system incorporating a T-tab on the cover thereof.

FIG. 14 is a perspective view of a prior art stackable storage system incorporating a wheeled lower storage container.

FIG. 15 is a right rear side perspective view of a stackable storage container according to a further embodiment of the invention.

FIG. 16 is a right front side perspective view of the stackable storage container shown in FIG. 15.

FIG. 17 is a top view of the stackable storage container shown in FIG. 15.

### DETAILED DESCRIPTION OF EXEMPLARY EMBODIMENTS

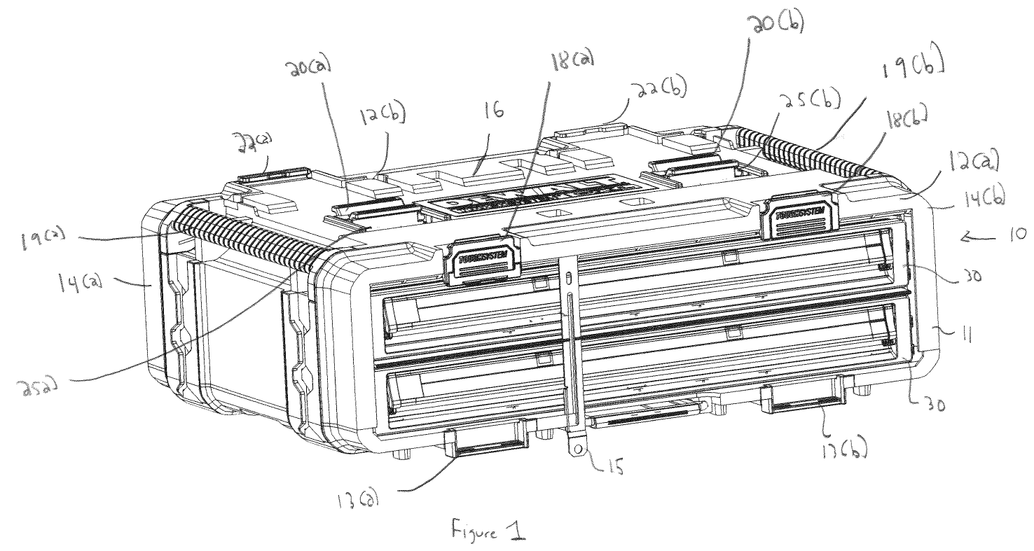

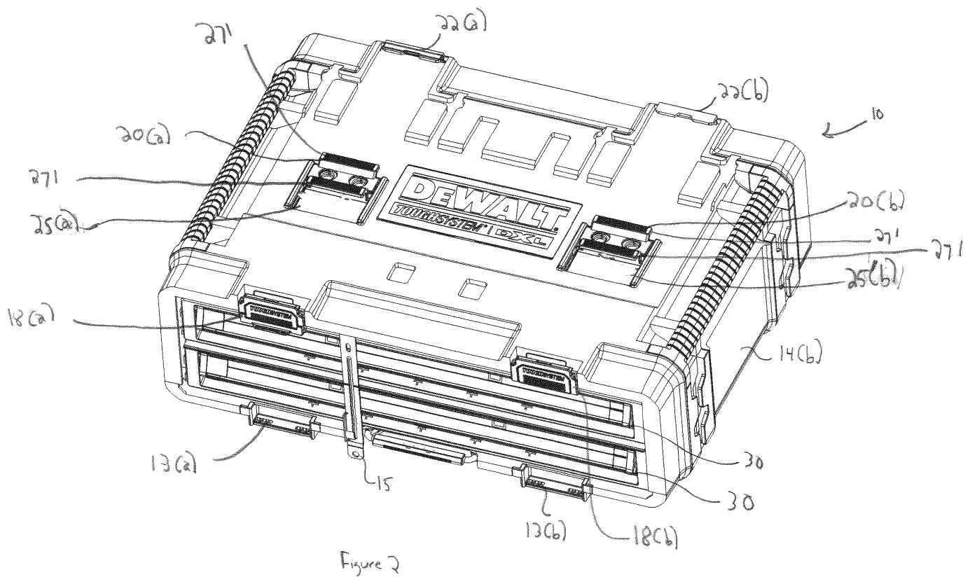

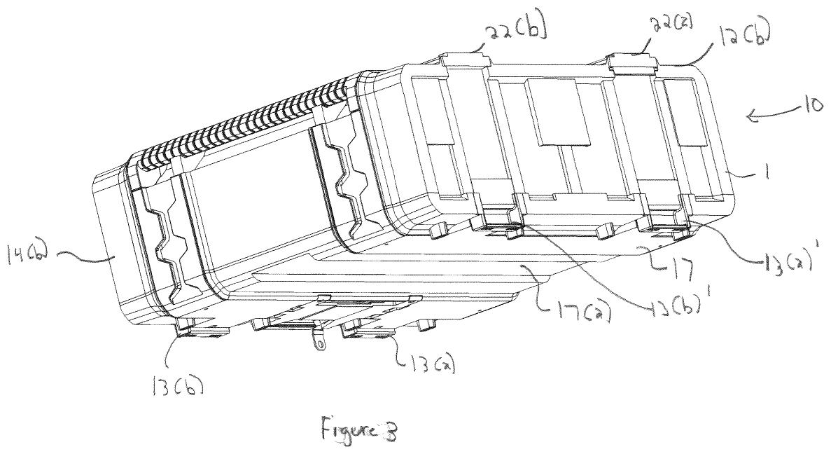

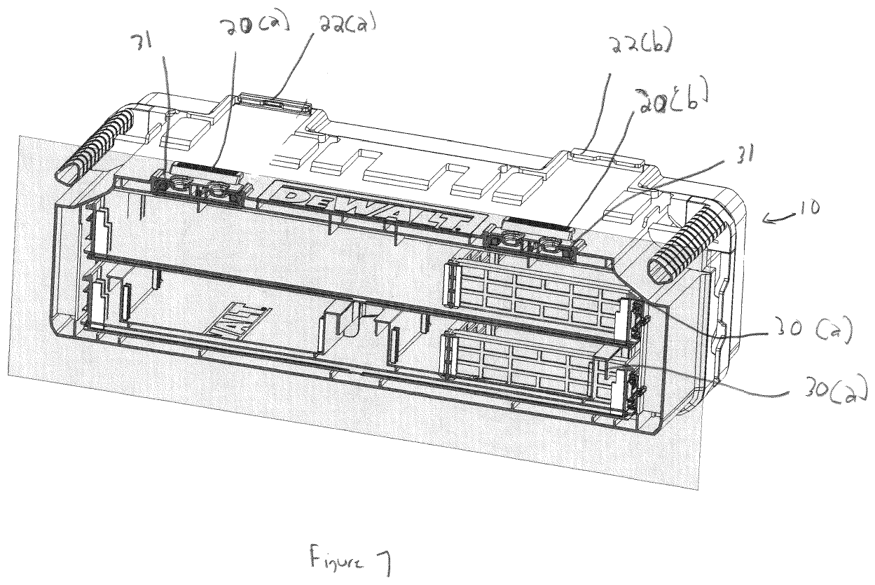

With reference to FIGS. 1-3, drawer storage module 10 includes drawer storage housing 11 having upper surface 16 extending between front long side 12(a), rear long side 12(b), left short side 14(a) and right short side 14(b). Front long side 12(a) is parallel to rear long side 12(b) and left short side 14(a) is parallel to right short side 14(b). The use of the terms front, rear, left, right, short and long are for the sake of description only and are not intended to limit the invention. Additionally, for the sake of convenience of description only, the direction extending between left short side 14(a) and right short side 14(b) shall be referred to as the longitudinal direction and the direction between front long side 12(a) and rear long side 12(b) shall be referred to as the lateral direction. Front long side 12(a) has an open face and one or more storage drawers 30 are slidably disposed therein which may be pulled out from front long side 12(a) to allow storage of tools or other items therein. Lock 15 may be rotated into or out of a position in front of storage drawers 30 to lock them in place in drawer storage housing 11. Left gripping handle 19(a) and right gripping handle 19(b) are integrally molded into drawer storage module 10. With reference to FIG. 7, drawers 30 may include separate compartments 30(a) formed therein.

Left spring loaded latch 18(a) and right spring storage latch 18(b) are disposed in channels formed on front long side 12(a) adjacent upper surface 16. Left latch 18(a) is disposed at a location between left short side 14(a) and a central vertical plane extending along the lateral direction and which bisects drawer storage module 10. Right latch 18(a) is symmetrically disposed between the central vertical plane and right short side 14(b), that is, on the opposite side of the central vertical plane from left latch 18(a). The structure and functioning of latches 18(a) and 18 (b) are substantially the same as the stacking latch mechanisms shown and described in the above-referenced U.S. Patent Application Publication Nos. 2020/0025229 and 2020/0298392, U.S. Pat. No. 11,486,427, and each include latch hooks extending inwardly relative to surface 16. Housing 11 includes front left step 13(a) and front right step 13(b) which extend downwardly from the lower edge of front long side 12(a) at a location below left latch 18(a) and right latch 18(b), respectively, and each also include a ledge. The structure of steps 13(a), 13(b) are similar to steps shown in the above-referenced applications and patent. The latch hooks of latches 18(a) and 18(b) may removably overlie steps 13(a) and 13(b), respectively, of a storage housing 11 of a second storage module 10 to removably secure one storage module 10 on top of the other on side thereof, in the same manner as the stackable containers shown in the incorporated applications and patent. Additionally and as further described below, containers of various sizes and also having steps similar to steps 13(a) and 13(b) may be secured to module 10 on upper surface 16.

Left and right upper rear side tabs 22(a) and 22(b) are formed on rear long side 12(b) at locations generally opposite left and right spring loaded latches 18(a) and 18(b), respectively. Tabs 22(a) and 22(b) are integrally molded with housing 11 and each have an overhanging ledge which extends above and substantially parallel to upper surface 16 in a spaced relationship thereto. Housing 11 includes rear lower left step 13(a)′ and rear lower right step 13(b) which extend downwardly from the lower edge of rear long side 12(b) at a location below left upper rear side tab 22(a) and right upper rear side tab 22(b), respectively. The structure of steps 13(a)′ and 13(b)′ are similar to steps 13(a) and 13(b).

Left and right sliding surface tabs 20(a) and 20(b) are slidably disposed on upper surface 16 and generally extend along a central vertical plane which extends along the longitudinal direction and which approximately bisects drawer storage module 10. Left sliding surface tab 20(a) is disposed between left spring loaded latch 18(a) and left upper rear side tab 22(a) and right sliding surface tab 20(b) is disposed between right spring loaded latch 18(b) and right upper rear side tab 22(b). Left and right sliding surface tabs 20(a) and 20(b) are each slidably disposed in the lateral direction and within left side indentation 25(a) and right side indentation 25(b), respectively, which are each formed in upper surface 16. Left sliding surface tab 20(a), left upper rear side tab 22(a) and left latch 18(a) are disposed in a linear arrangement such that all three elements are intersected by a vertical plane extending in the lateral direction, with plane generally bisection the elements. The same arrangement is true of right sliding surface tab 20(b), right rear side tab 22(b) and right latch 18(b).

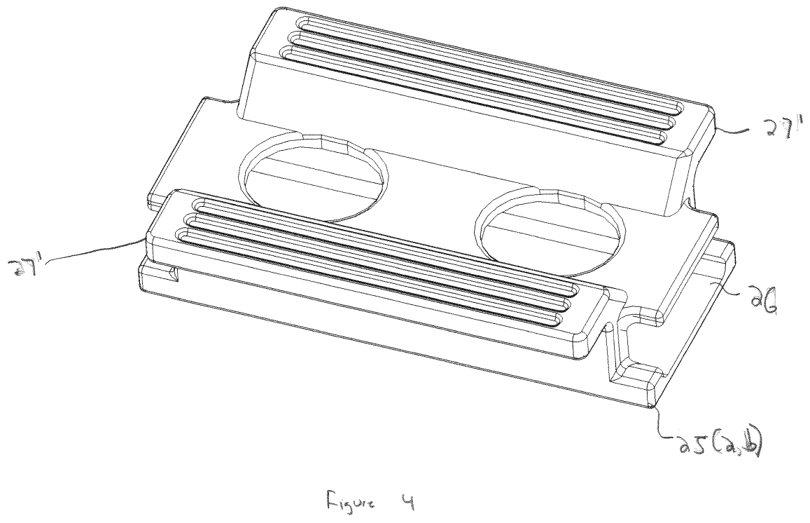

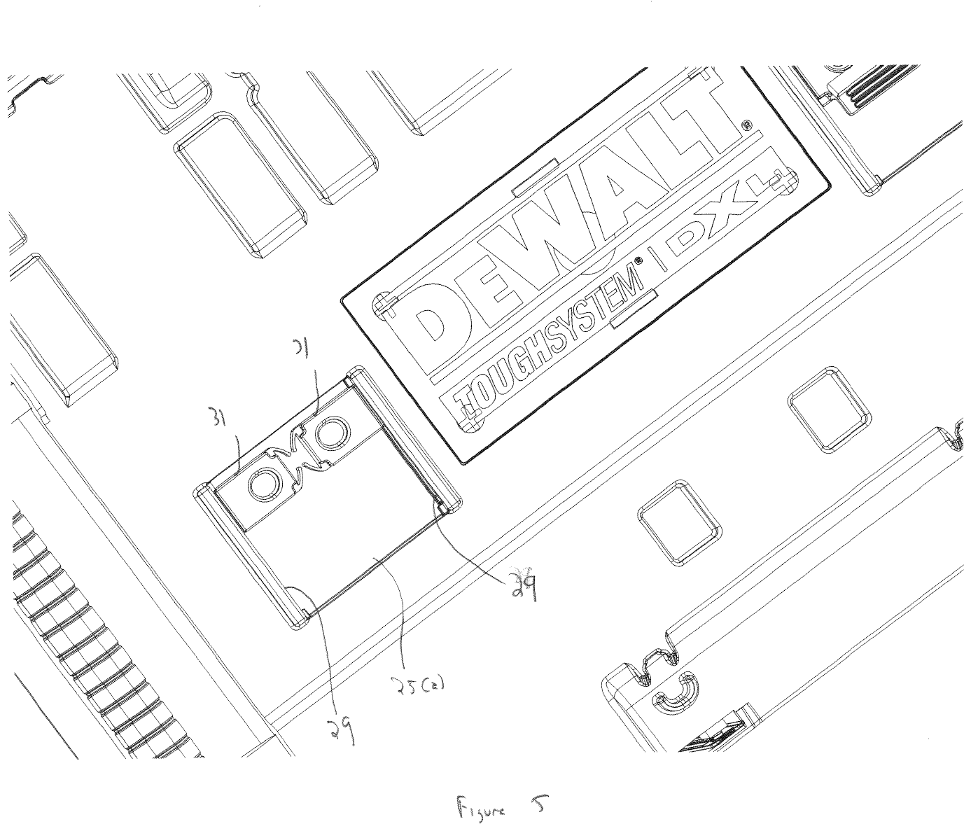

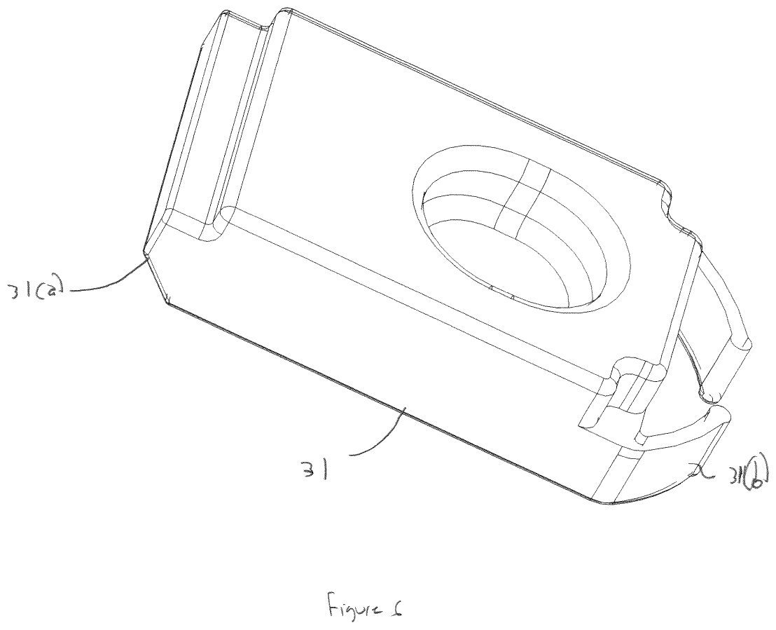

With further reference to FIGS. 4 and 5, each of sliding surface tabs 22(a) and 22(b) include a longitudinally extending body having upper and lower surfaces defining an interior volume which is open at left and right side openings 26. Front and rear overhanging hooks or ledges, each of which is numbered as 27′, which extend outwardly from the upper surface. Overhanging ledges 27′ extend in the longitudinal direction and are displaced from the surface of indentations 25(a) and 25(b). Indentations 25(a) and (b) each include left and right side channels 29 which are each formed below opposite side laterally extending overhanging walls formed in indentations 25(a) and 25(b). With reference to FIG. 6, locking tabs 31 each include a laterally outward protrusion 31(a) and hook springs 31(b) disposed oppositely of protrusions 31(a). Locking tabs 31 are force fitted into side openings 26 of sliding tabs 20(a) and (b), with hook springs 31(b) biased outwardly to secure tabs 22(a) and 22(b) on locking tabs 31. Protrusions 31(a) of each tabs 20(a) or 20(b) fit within and are secured under the left and rights side channels 29 to allows tabs 20(a) and 20(b) to be slid in the lateral direction in indentations 25(a) and 25(b). Tabs 20(a) and 20(b) may therefore be moved forwardly and rearwardly in indentations 25(a) and (b). The sliding movement of tabs 20(a) and 20(b) is thus in the lateral direction, generally perpendicular to front long side 12(a) and rear long side 12(b) and parallel to left short side 14(a) and right short side 14(b).

One drawer storage module 10 may be secured on the upper surface 16 of another drawer storage module 10 by inserting rear lower left step 13(a)′ and rear lower right step 13(b)′ of the upper storage module 10 beneath the corresponding upper left rear side tab 22(a) and upper right rear side tab 22(b) of the lower storage module. The upper storage module 10 would then be lowered fully onto the lower storage module 10 with left front lower step 13(a) and right front lower step 13(b) of the upper module 10 contacting and then sliding beneath the hooks of left spring loaded latch 18(a) and right spring loaded latch 18(b), in the same manner as described in the above-referenced patent applications and patent. The hooks of latches 18(a) and 18(b) overlie front lower left step 13(a) and front lower right step 12(b) to secure the front of the upper storage module 10 to the lower storage module 10.

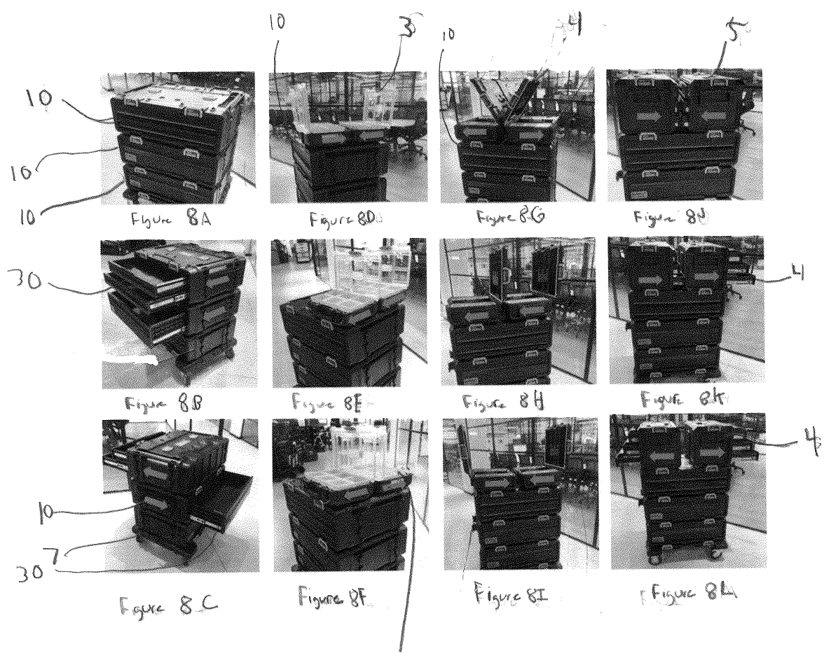

With reference to FIGS. 8A-8C, various configuration for stacking drawer storage module upon each other are shown. Three drawer storage modules 10 are shown, with the lower module 10 secured on dolly 7 which also includes latches having the same structure as spring loaded latches 18(a) and 18(b). The drawer storage modules 10 are stacked upon each other, with the lowest drawer storage module 10 stacked on dolly 7. In FIGS. 8A and 8B, front sides 12(a) of all of drawer storage modules 10 face the same direction such that slidable drawers 30 all open towards the same side. However, in FIG. 8C, the middle storage module 10 of the stack is orientated in the opposite direction so that the drawers 30 thereof open oppositely from the drawers 30 of the other two. Although the stacking of drawer storage modules 10 has been described, a full sized container having front and rear, left and right steps also could be stacked on top of a drawer storage module 10 in the same manner.

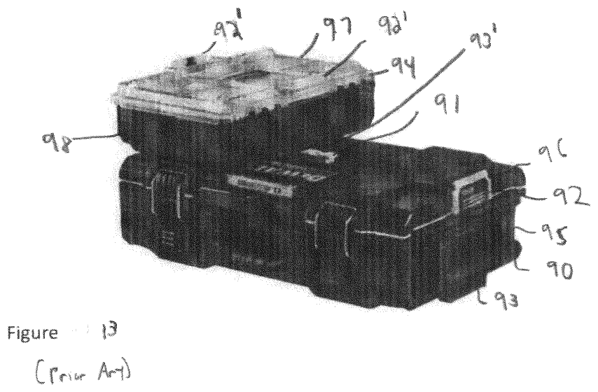

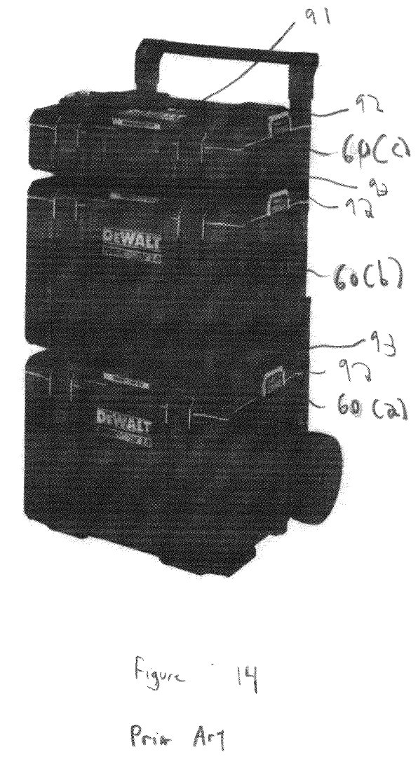

With reference to FIGS. 8D-8L, the various configurations in which containers of various sizes may be removably secured on upper surface 16 of storage module 10 is shown. The containers may be, for example, compartmentalized accessory box 3, similar in structure to accessory box 94 described with reference to FIG. 13, which includes a container base and lid, with the base having lower steps extending from opposite front and rear sides thereof, at a central location in the lateral direction. (For purposes of description front and rear are defined as the side from which the lid moves upwardly away, and the side which the lid is secured to and which serves as the pivot axis, respectively.) The lid is pivotably secured at one upper end of the container and may also have a latch similar to spring loaded latches 18(a) or 18(b) at the upper front side and a tab similar to rear side tabs 22(a) and (b) at an upper rear side. Accessory boxes 3 have an overall area (defined on the upper or lower surfaces) of about one quarter that of the area of upper surface 16. Large container 5 is similarly in structure to container 60(b) described above having a base and a cover, with steps formed on the lower left and right sides of the base and spring loaded latches formed on the left and rights side of the cover. Large container 5 has an area which is about one half that of the area of upper surface 16. Finally small container 4 has a structure similar to that of large container 5, with an area of about one half that of the area of upper surface 16, but with a smaller depth than larger container 5.

With reference to FIGS. 8D, 8E and 8F, two accessory boxes 3 are disposed on the right side of drawer storage module 10. In FIG. 8D, the accessory boxes 3 are orientated such that the front sides thereof are adjacent each other near the longitudinal vertical central plane of module 10 such that when the lids of boxes 3 are opened, one of the lids extends vertically above front long side 12(a) and the other lid extends vertically above rear long side 12(b) of drawer storage module 10. When the lids are opened in this configuration, the interior surfaces thereof (that is, the surfaces which face the interior accessory storage volumes when the lids are closed) face each other. In other words, accessory boxes 3 are both opened to face inwardly towards the longitudinal vertical central plane. In FIG. 8E, the orientation of the front accessory box 3 is reversed such that when the lid thereof is opened it extends vertically over the longitudinal vertical central plane of storage module 10. In this situation, the exterior surface of the lid of the front accessory box 3 faces the interior surface of the lid of the rear accessory box 3. In other words, the rear accessory box 3 is opened to face inwardly and the front accessory box 3 is opened to face outwardly, or in still further words, both boxes 3 are opened to face forwardly. In FIG. 8F the front sides of both accessory boxes 3 are oriented so as to be disposed over the longitudinal vertical central plane such that the lids are opened in the opposite orientation, with the exterior surface of one lid facing and adjacent to the exterior surface of the other lid. In other words, both the front and rear accessory box 3 are opened to face outwardly, or in still further words, front accessory box 3 is opened to face forwardly and rear accessory box 3 is opened to face rearwardly. Though only two boxes 3 are shown, two additional boxes could be secured on the left side of surface 16 such that a total of four accessory boxes 3 can be secured on drawer storage module 10.

In FIGS. 8G, 8H and 8I, two small containers 4 are disposed on surface 16, with one container disposed on each of the left or right side of the surface. One step of each smaller container 4 is secured beneath one of rear tabs 22(a) or 22(b), and the other step of each small container 4 is secured beneath the associated spring-loaded latch 18(a) or 18(b). Containers 4 each thus extend entirely across one half of upper surface 16 in the lateral direction, and open to face leftward or rightward, as opposed to the forward or rearward opening directions of accessory boxes 3. In FIG. 8G, containers 4 are disposed such that the lids are adjacent to each other when opened, at a location above the lateral central vertical plane of storage module 10. Therefore, the exterior surfaces of the lids face each other and the containers open outwardly in the same manner as described in FIG. 8F but in the left and right directions. In FIG. 8H, the orientation of the right side container 4 is reversed such that the lid thereof extends vertically over short right side 14(b) and the interior surface of the lid of the right side container 4 faces the exterior surface of the lid of left side container 4 when the lids are open. In other words, the left small container 4 is opened to face outwardly and the right small container 4 is opened to face outwardly, or in still further words, both containers 4 are opened to face leftward. In FIG. 8I, the orientation of left side container 4 is reversed such that the lid thereof extends over short left side 14(a), and the interior surfaces of both lids face each other. In other words, both small containers 4 are opened to face inwardly.

FIGS. 8J, 8K and 8L show similar orientations as FIGS. 8G, 8H and 8I but for large container 5. In each of the drawings, the lids are shown in the closed position. The orientation shown in FIG. 8J is the same as in FIG. 8I, the orientation shown in FIG. 8K is the opposite of FIG. 8H and the orientation of FIG. 8L is the same as FIG. 8G.

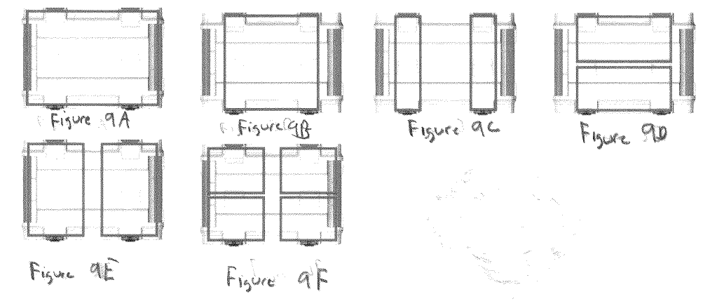

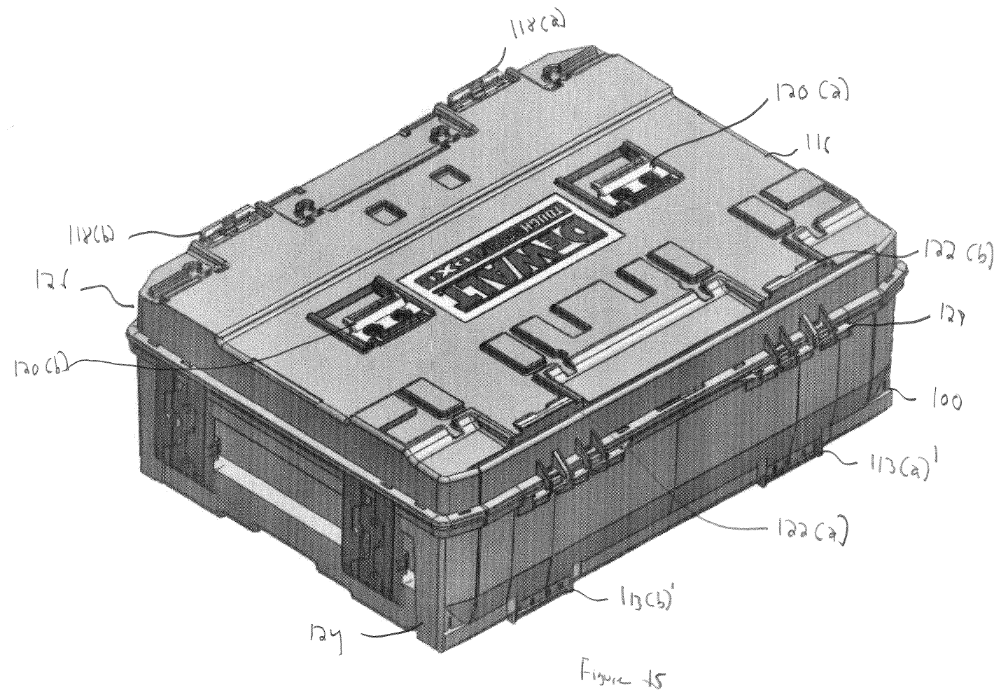

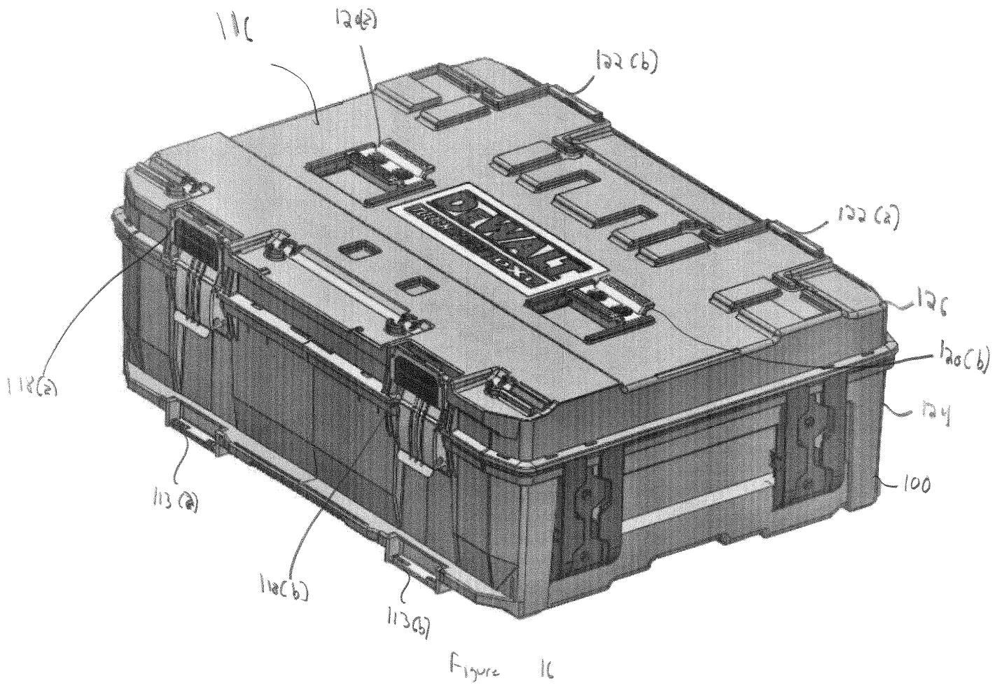

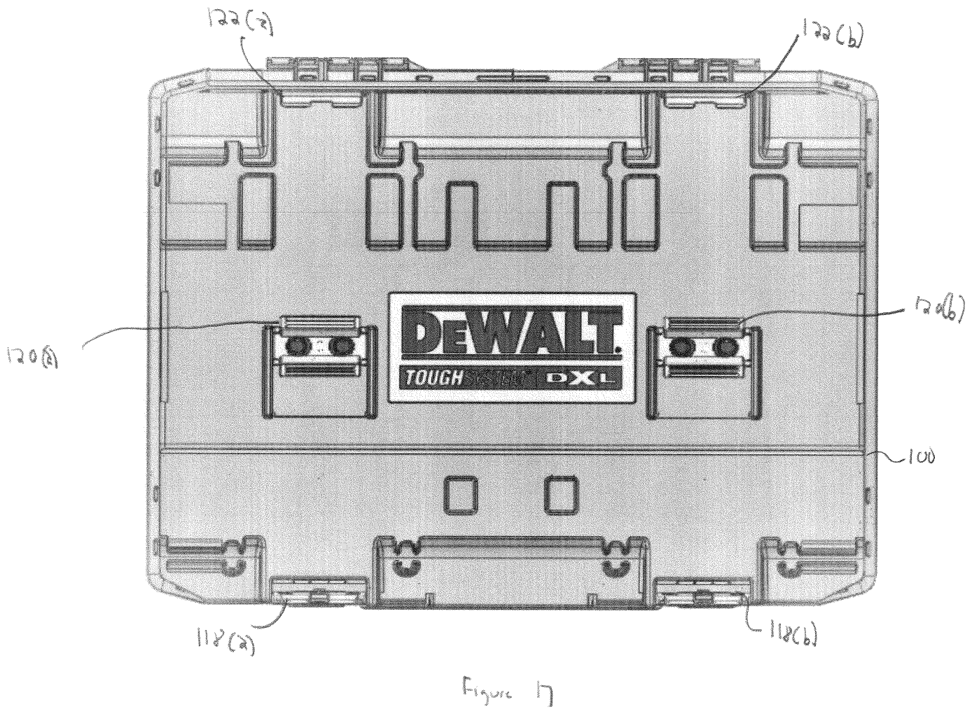

With reference to FIGS. 9A-9F, block diagrams are shown which illustrate the possible sizes and orientations of containers of various sizes which may be stacked on drawer storage module 10. The containers in each case are shown in block form. In FIG. 9A, a full sized component, which may be another drawer storage module 10 or container 100 described below with reference to FIGS. 15-17, is secured on a lower module 10 and extends entirely across upper surface 16. The component incudes four lower steps and is secured between both pairs of rear side tabs 22(a),(b) and spring loaded latches 18(a),(b). In FIG. 9B, a container having a slightly less width than that of the container shown in FIG. 9A such that is does not extend entirely across upper surface 16 is shown. The container in FIG. 9B also includes four lower steps to be secured between both pairs of rear side tabs 22(a),(b) and spring loaded latches 18(a),(b) in the same manner as the container in FIG. 9A. In FIG. 9C, two thin boxes having widths which are less than containers 4 or 5 have left and right steps formed on the lower sides and each extend across the left and right sides of upper surface 16, with each box secured between one pair of side tabs 22(a),(b) and spring loaded latches 18(a),(b). In FIG. 9D, two half sized containers extend laterally across the front and rear areas of upper surface 16. The rear container in FIG. 9D is secured between both side tabs 22(a) and 22(b) and respective sliding tabs 20(a) and 20(b), while the front box is secured between sliding tabs 20(a) and 20(b) at the opposite ledge and spring loaded latches 18(a) and 18(b). In FIG. 9E two container are disclosed in the same orientation as the containers in FIG. 9C, however the containers are half sized containers and have a larger width. In FIG. 9F, four quarter sized containers are shown and with each of the rearward containers secured between one of rear side tabs 22(a) or 22(b) and an associated sliding tab 20(a) or 20(b), and each of the front containers secured between one of sliding tabs 20(a) or 20(b) and the associated spring loaded latch 18(a) or 18(b).

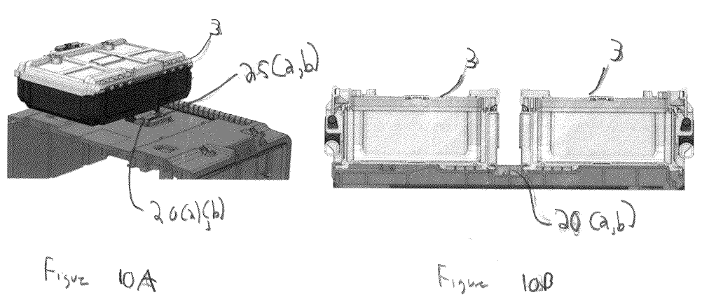

With reference to FIGS. 10A-10B, the manner in which containers which extend only half-way across upper surface 16 in the lateral direction are secured to upper surface 16 is shown (for example, the orientation shown in FIGS. 8D-8F and FIG. 9F). In particular quarter-sized small accessory boxes 3 having front and rear lower steps are shown. A first accessory box 3 is placed on upper surface 16 with one of the lower steps slid beneath the overhanging ledge of either rear left side tab 22(a) or rear right side tab 22(b). Thereafter, the associated sliding tab 20(a) or 20(b) is slid rearwardly in indentation 25(a) or 25(b) such that rear overhanging hook or ledge 27′ overlies the other lower step of small container 3 to secure small container 3 on upper surface 16 at a rearward location, as shown in FIG. 10A. Thereafter, a second accessory box 3 is placed on upper surface 16 at a location forward of the first accessory box 3, with one lower step of second accessory box 3 disposed beneath front overhanging hook or ledge 27′ of the associated sliding tab 20(a) or 20(b). Thereafter, the forward portion of second accessory box 3 is brought down into full contact with upper surface 16 such that the opposite step of accessory box 3 contacts and slides over the associated spring loaded latch 18(a) or 18(b) to be secured beneath the latching hook thereof, in the manner described in the above-referenced incorporated patent applications and patent to fully secure the second accessory container 3 on upper surface 16 as shown in FIG. 10B. The procedure may be repeated on the other side (left or right) of upper surface 16 such that four quarter-sized accessory boxes 3 can be secured on upper surface 16. (Latches 18(a),(b) are not shown in FIGS. 10A-B.) Although a quarter size accessory box is described, quarter sized small containers could also be secured in this manner.

Alternatively, as described above, two half-sized containers (4 or 5) can be secured on upper surface 16. In each case the lower step of the containers would be disposed beneath one of left side tab 22(a) or right side tab 22(b) and the container would be lowered towards upper surface 16 with the other step of the container (4 or 5) contacting and sliding over the respective left spring loaded latch 18(a) or right spring loaded latch 18(b) to be secured beneath the latching hook thereof as described above. A second large container could be disposed on the opposite side of upper surface 16 to extend between the other of the side tabs and latches. The containers 4 would have a channel formed on the lower surface thereof to receive tabs 20(a) and 20(b) to allow the lower surfaces of the containers (4 or 5) and upper surface 16 to come into contact. Although containers which extend laterally across the left or right side of upper surface 16 are shown, containers which extend fully across the front or rear sides of upper surface 16 could also be incorporated. In the latter case, the steps of the containers would be formed on the lower front and rear sides, as opposed to the lower left and right sides.

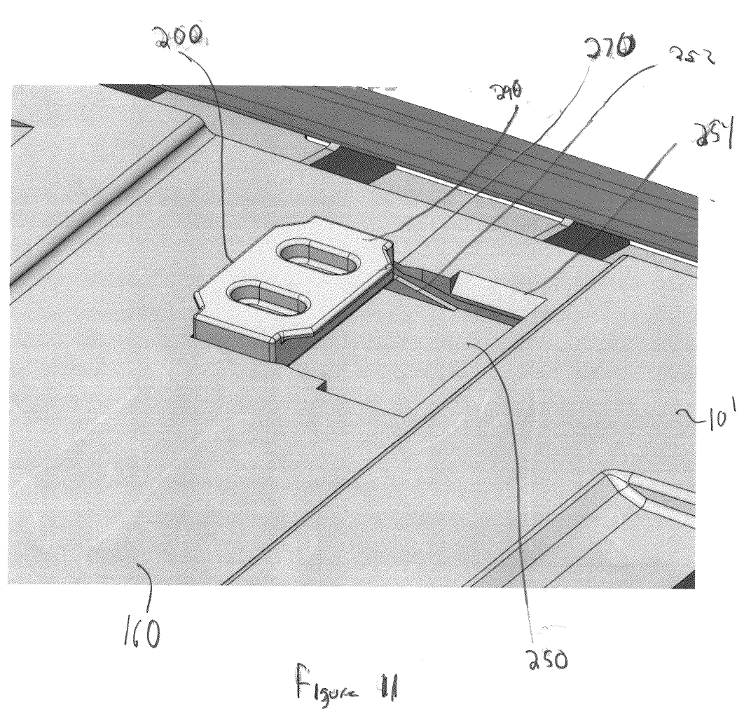

With reference to FIG. 11 an alternative structure is disclosed. Drawer storage module 10′ includes sliding tab 200 which includes front and rear overhanging ledges 270 which have a similar structure to ledges 27′. Tab 200 is slidably disposed in indentation 250 which includes an inclined ramp 252. Tab 200 is shown in its forward position (closer to front long side 12(a) in which it is vertically displaced to the maximum extent relative to indentation 250 with overhanging ledges 270 displaced from upper surface 160. When sliding tab 200 is moved rearwardly in indention 250, it slides down ramp 252 such that ledges 270 are in substantially the same plane as upper surface 160, with rear ledge 270 disposed beneath ledge 254. Therefore, tab 200 does not interfere with the lower surface of an upper module or box when it is disposed on upper surface 160 so that no channel is needed in the lower surface of the upper container, box or module. In all other respects, drawer storage module 10′ would have the same structure as drawer storage module 10.

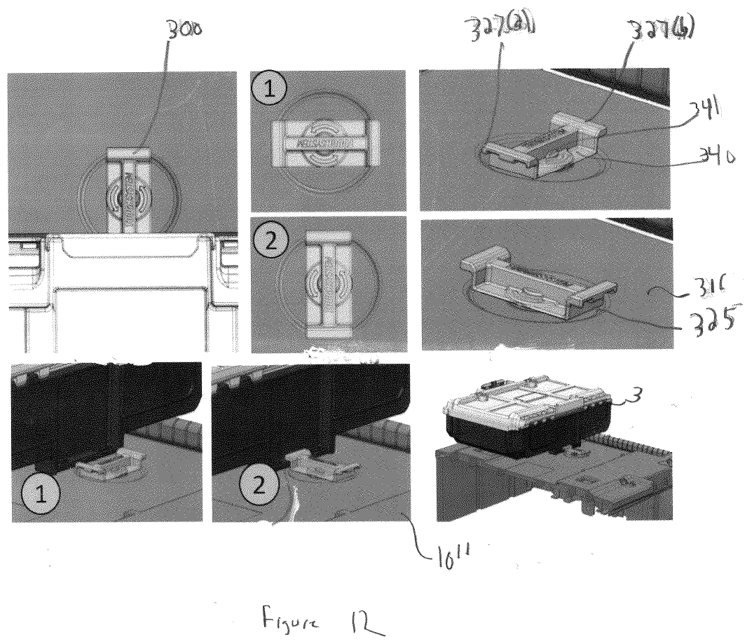

With reference to FIG. 12, several views of the upper surface of a further alternative structure is disclosed. Drawer storage module 10″ includes tab 300 which is rotatably secured in circular indentation 325 formed on upper surface 316 of the drawer storage module. Tab 300 includes two ledges 327(a) and 327(b) and rotates about axis 341. In order to secure a quarter-sized box on upper surface 316, tab 300 is placed in its initial position in which the longer dimension thereof extends along the longitudinal axis of upper surface 160. That is, left and right ledges 327(a) and 327(b) each face towards one of the left and right short surfaces of the drawer storage module. A quarter-sized container or box is then place on upper surface 316 on a rearward portion thereof, that is, in one of the rear quarter regions, with the rear lower stop of the container or box received under the overhanging ledge of one of the rear tabs having the same structures as tabs 22(a),(b). This position is marked as “1” in FIG. 12 in the lower left quadrant, and tab 300 extends longitudinally along and out of contact with the step. Thereafter tab 300 is rotated such that one of ledges 327(a) or 327(b) is disposed over the lower step of the container to thereby secure the container on surface 316, as shown in the lower center and lower right quadrant of FIG. 12 (and marked as 2). Thereafter, a second quarter sized container can be disposed between the other of ledges 327(a) or 327(b) and one of the spring loaded latches. In all other respects, drawer storage module 10′ would have the same structure as drawer storage module 10.

With reference to FIGS. 15-17, a further embodiment of the invention is shown. Container 100 includes base 124 having an interior storage volume and cover 126 pivotably attached to base 124 about conventional pivot hinges and rods shown generally as element 127 to open and close the interior storage volume. Cover 126 has upper surface 116 extending between left and right short sides and front and rear long sides. Left spring loaded latch 118(a) and right spring loaded latch 118(b) are disposed on the front long side of cover 126 and have structures and locations substantially identical to left spring loaded latch 18(a) and right spring loaded latch 18(b) as described in the first embodiment. Base 124 includes front left step 113(a) and front right step 113(b) which extend downwardly from the lower edge of the front long side at a location below left latch 118(a) and right latch 118(b), respectively, and include a ledge. The structure and locations of steps 113(a) and 113(b) are similar to steps 13(a) and 13(b) as described in the first embodiment. Left and right upper rear side tabs 122(a) and 122(b) are formed on the rear long side of cover 126 at locations generally opposite left and right spring loaded latches 118(a) and 118(b), respectively, and have a structure and locations similar to left and right rear side tabs 18(a) and 18(b) as described in the first embodiment. Left and right sliding surface tabs 120(a) and 120(b) are disposed on upper surface 116 and generally extend along a central vertical plane which extends along the longitudinal direction and which bisects container 100. Left sliding surface tab 120(a) is disposed between left spring loaded latch 118(a) and left side rear tab 122(a) and right sliding surface tab 120(b) is disposed between right side spring loaded latch 118(b) and right rear side tab 122(b). Left and right sliding surface tabs 120(a) and 120(b) have a structure and locations similar to left and right sliding surface tabs 20(a) and 20(b) described in the first embodiment. Base 124 includes rear lower left step 113(a)′ and rear lower right step 113(b)′ which extend downwardly from the lower edge of the rear long side below left upper rear side tab 122(a) and right upper rear side tab 122(b), respectively. The structure and location of steps 113(a)′, 113(b)′ are similar to steps 13(a)′ and 13(b)′ described in the first embodiment.

Container 100 may be stacked upon other containers 100 and on top of or beneath drawer storage module 10 in the same manner as described above with respect to the stacking of drawer storage modules 10. In addition, accessory boxes 3, small containers 4 and large containers 5 may be secured on surface 116 in the same manner as shown and described with respect to drawer storage module 10 in FIGS. 8A-8L. The orientations in which various sized containers may be secured to surface 16 as described in FIGS. 9A-9F is also applicable to container 100. Sliding surface tabs 120(a) and 120(b) function as shown and described with reference to FIGS. 10A-10B and sliding surface tabs 20(a) and 20(b) to secure the various sized containers on surface 116.

While the invention has been described by way of exemplary embodiments, it is understood that the words which have been used herein are words of description, rather than words of limitation. Changes may be made within the purview of the appended claims, without departing from the scope and spirit of the invention in its broader aspects.

1. A drawer storage module comprising:
a drawer storage housing having first and second sides and further including an upper surface extending between said first and second sides, said drawer storage module housing including first and second latches secured adjacent said upper surface on one of said first and second sides, first and second side tabs disposed adjacent said upper surface on the other of said first and second sides opposite said first and second latches, respectively, and having ledges overhanging said upper surface, and first and second surface tabs projecting upwardly from said upper surface, each said surface tab having a pair of ledges spaced from said upper surface, said first surface tab disposed between said first latch and said first side tab and said second surface tab disposed between said second latch and said second side tab;
and at least one storage drawer slidable into and out of said drawer storage housing; wherein,
a first container having an interior storage space and a pair of first container steps formed on opposite lower sides thereof may be removably disposed on said upper surface with one of said pair of first container steps secured beneath one of said first or second latches and the other of said pair of first container steps secured beneath the ledge of the corresponding opposite first side tab or second side tab, and a second container having an interior storage space and a pair of second container steps formed on opposite lower sides thereof may be removably disposed on said upper surface in both a first configuration in which one of said pair of second container steps is secured beneath one of said first or second latches and the other of said pair of second container steps is secured beneath a ledge of one of a corresponding first or second surface tabs, or in a second configuration in which one of said pair of second container steps is secured beneath a ledge of one of a corresponding first or second surface tab and beneath the ledge of the corresponding first side tab or second side tab.

2. The drawer storage module recited in claim 1, wherein said pair of ledges of each of said first and second surface tabs extend substantially parallel to the ledges of the corresponding first or second side tab.

3. The drawer storage module recited in claim 2, wherein, said first and second surface tabs are movable along said surface towards and away from said first and second sides, wherein,
the second container may be removably secured on said surface in the second configuration by disposing one of the second container steps beneath a ledge of one said first and second side tab, and then moving the corresponding first or second surface tab towards the second container such that one ledge of the corresponding first or second surface tab overlies the other of the second container steps, and wherein a third container having a having an interior storage space and a pair of third container steps formed on opposite lower sides thereof may be removably secured on said surface by disposing one of the third container steps beneath the other ledge of the corresponding first or second surface tab and disposing the other of the third container steps beneath the corresponding first or second latch.

4. The drawer storage module recited in claim 3, wherein, said drawer is slidable along a direction which is perpendicular to said first and second sides.

5. The drawer storage module recited in claim 1, wherein said first and second surface tabs may be raised and lowered relative to said surface.

6. The drawer storage module recited in claim 1, wherein, said first and second surface tabs are rotatable relative to said surface between a first position in which said first and second surface tab ledges are substantially parallel to said ledges of said first and second side tabs and a position in which said first and second surface tab ledges are not substantially perpendicular to said ledges of said first and second side tabs.

7. The drawer storage module recited in claim 6, wherein the second container may be removably secured on said surface in the second configuration by disposing one of the second container steps beneath a ledge of one said first and second side tab, and then rotating the corresponding first or second surface tab such that one ledge of the corresponding first or second surface tab overlies the other of the second container steps, and wherein a third container having a having an interior storage space and a pair of third container steps formed on opposite lower sides thereof may be removably secured on said surface by disposing one of the third container steps beneath the other ledge of the corresponding first or second surface tab and disposing the other of the third container steps beneath the corresponding first or second latch.

8. The drawer storage module recited in claim 1, wherein, said drawer is slidable along a direction which is perpendicular to said first and second side.

9. A container system comprising a drawer storage module, a first container and a second container, said drawer storage module comprising:
a drawer storage housing having first and second sides and further including an upper surface extending between said first and second sides, said drawer storage module housing including first and second latches secured adjacent said upper surface on one of said first and second sides, first and second side tabs disposed adjacent said upper surface on the other of said first and second sides opposite said first and second latches, respectively, and having ledges overhanging said upper surface, and first and second surface tabs projecting upwardly from said upper surface, each said surface tab having a pair of ledges spaced from said upper surface, said first surface tab disposed between said first latch and said first side tab and said second surface tab disposed between said second latch and said second side tab, and
at least one storage drawer slidable into and out of said drawer storage module housing; wherein;
said first container comprises an interior storage space and a pair of first container steps formed on opposite lower sides thereof; wherein said first container may be removably disposed on said upper surface in a first configuration in which one of said pair of first container steps is secured beneath one of said first or second latches and the other of said pair of first container steps is secured beneath a ledge of one of the corresponding first or second surface tab, or in a second configuration in which one of said pair of first container steps is secured beneath a ledge of one of a first or second surface tab and the other of said pair of first container steps is secured beneath the ledge of the corresponding first side tab or second side tab.

10. The drawer storage module recited in claim 9, wherein said pair of ledges of each of said first and second surface tabs extend substantially parallel to the ledges of the corresponding first or second side tab.

11. The container system recited in claim 10 further comprising a second container having an interior storage space and a pair of second container steps formed on opposite lower sides thereof, wherein, the first container may be removably secured on said surface in the first configuration and the second container may be removable secured on said surface in the second configuration.

12. The container system recited in claim 11, wherein, said drawer is slidable along a direction which is perpendicular to said first and second side.

13. The container system recited in claim 9, wherein said first and second surface tabs may be raised and lowered relative to said surface.

14. The container system recited in claim 9, wherein, said first and second surface tabs are rotatable relative to said surface between a first position in which said first and second surface tab ledges are substantially parallel to said ledges of said first and second side tabs and a position in which said first and second surface tab ledges are not substantially perpendicular to said ledges of said first and second side tabs.

15. The container system recited in claim 9, wherein, said drawer is slidable along a direction which is perpendicular to said first and second sides.

16-22. (canceled)

23. A drawer storage module comprising:
a drawer storage housing having first and second sides and further including an upper surface extending between said first and second sides, said drawer storage module housing including first and second latches secured adjacent said upper surface on one of said first and second sides, first and second side tabs disposed adjacent said upper surface on the other of said first and second sides opposite said first and second latches, respectively, and having ledges overhanging said upper surface, and first and second surface tabs projecting upwardly from said upper surface, each said surface tab having a pair of ledges spaced from said upper surface, said first surface tab disposed between said first latch and said first side tab and said second surface tab disposed between said second latch and said second side tab;
and at least one storage drawer slidable into and out of said drawer storage housing.

24. The drawer storage module recited in claim 23, wherein, said first and second surface tabs are movable surface towards and away from said first and second sides.

25. The drawer storage module recited in claim 23, wherein, said first and second surface tabs are rotatable relative to said surface between a first position in which said first and second surface tab ledges are substantially parallel to said ledges of said first and second side tabs and a position in which said first and second surface tab ledges are not substantially perpendicular to said ledges of said first and second side tabs.

26. The drawer storage module recited in claim 23 further comprising steps projecting from a lower surface thereof, each of said steps disposed beneath one of said side tabs or said latches.
